(19) United States
(12) Patent Application Publication
(10) Pub. No.: US 2005/0068759 A1
(43) Pub. Date: Mar. 31, 2005

(54) Light control sheet and method of manufacturing the sheet

(76) Inventors: Hiroyuki Takemoto, Hyogo (JP); Masanari Ohnishi, Hyogo (JP)

Correspondence Address: BIRCH STEWART KOLASCH & BIRCH, PO BOX 747, FALLS CHURCH, VA, 22040-0747, US

(21) Appl. No.: 10/492,079

(22) PCT Filed: Oct. 7, 2002
(86) PCT No.: PCT/JP02/10425

(30) Foreign Application Priority Data
Oct. 12, 2001 (JP) 2001-315578
Nov. 29, 2001 (JP) 2001-365284

(51) Int. Cl. F21V 7/04

(52) U.S. Cl. 362/31

(57) ABSTRACT

A light control sheet 1 having a platelike particle 3 (e.g., a mica) dispersedly oriented in a transparent resin 2 is obtained by laminating a plurality of transparent resin sheets in which the plate surface of the platelike particle is oriented along the sheet surface, welding these sheets to each other, and slicing the resulting matter in an intersecting direction relative to the laminating direction. The platelike particle comprises a transparent particle or a reflective particle. The direction of the plate surface of the fine particle is inclined to the sheet surface, and the angle θ of the plate surface of the platelike particle 3 to the plane of the sheet 1 is about 45 to 90°. Thus obtained light control sheet has a function in which an incident light in a specific angle range is selectively scattered, or a function in which an angle dependence of brightness can be improved even when a light source is locally disposed to a display surface or a light guide plate.

### TECHNICAL FIELD

The present invention relates to a light control sheet not only improving in luminance or an angle dependence of brightness (or luminance) but also selectively scattering lights entered with various angles, and useful for decoration, in optical system of a display apparatus such as a liquid crystal display apparatus, as well as a process for producing the sheet.

Moreover, the invention relates to a light control sheet that ensures improvement in an angle dependence of brightness (or luminance) in a back light unit for illuminating a display surface of a display apparatus (such as a liquid crystal display apparatus) from a back side thereof with a tubular light source (a back light unit having a one-sided light source lamp), as well as a process for producing the sheet.

### BACKGROUND ART

Up to now, a light-diffusing sheet has been used in order to improve luminance or an angle dependence of brightness, luminance uniformity or others, in a liquid crystal display apparatus. For example, the light-diffusing sheet diffuses a light emitted from a light guide plate of a back light, gives the diffused light an angle dependence of brightness conforming a characteristic of viewing angle of a display device, and tries to improve the efficiency of the back light. Moreover, in accordance with advance of display quality, decrease in electricity consumption or others, further improvement in luminance or an angle range maintaining luminance has been recently required. In order to realize such a characteristic, it has been indispensable to use a sheet having selectivity of incident angle of light such that only lights in a specific angle range are selectively diffused, or having a high degree of a light control function, e.g., an axis-shifted scattering such that an incident direction and a maximum direction of a scattering intensity are shifted from each other or an asymmetric scattering relative to an incident direction. However, since a conventional light-scattering sheet is produced by mat finishing a surface of a transparent resin sheet, by dispersing a scattering fine particle into the inside of the transparent resin sheet, or by other means, the sheet does not have the foregoing light control function.

Japanese Patent No. 2691543 description discloses a sheet obtained by hardening a polymerizable monomer or oligomer, wherein the sheet is so structured that layers different from each other in refractive index are arranged with lying one upon another. The sheet having such a structure improves selectivity of incident light angle. However, such a sheet is produced by photo-curing based on holography technology, resulting in generation of interference colors or significant increase of production cost.

Japanese Patent Application Laid-Open No. 171619/2000 (JP-2000-171619A) discloses an anisotropic light-scattering film, wherein sections different from each other in refractive index are distributed within the film at an irregular shape and thickness, thereby light and dark patterns in refractive index are formed due to a scattering factor, and the sections different from each other in refractive index are distributed in layers with having an inclination with respect to the thickness direction of the film. The sheet ensures improvement in selectivity of incident light, and an axis-shifted scattering effect. Such a light control sheet, as described in Japanese Patent Application Laid-Open No. 214311/2000 (JP-2000-214311A), realizes a bright and high definition display in using for a reflective liquid crystal display apparatus. Moreover, generation of interference color can be inhibited by making the shape and thickness of the scattering factor irregular. However, due to irregularity of the shape and thickness of the scattering factor, directivity of the scattering light is deteriorated, or selectivity of the incident angle of light is decreased. That is, in an angle range in which an incident light should originally penetrate without scattering, scatteration is still generated. Further, the sheet is also produced through the use of holography technology, resulting in significantly increasing production cost.

On the other hand, Japanese Patent Application Laid-Open No. 338311/2000 (JP-2000-338311A) proposes a light-scattering sheet, into which sections different from each other in refraction index and each formed of an elliptical piece are dispersed with arranging the major-axial directions and the minor-axial directions thereof, and which has a structure formed as a dark and light pattern based on the reflective index. However, such a structure extremely lacks in selectivity of incident light angle, and isotropic scattering cannot be substantially expected. Moreover, it is difficult to materialize the above-mentioned structure, and the materialization is not easy even if using holography technology.

Moreover, in a liquid crystal display apparatus, has been required not only improvement in display quality but also thin-reducing and weight-saving and low electrical consumption. Also in a back light unit for illuminating a liquid crystal display surface from the back face of the back light unit, compatibility of improvement in front luminance and thin-reducing and weight-saving with low electrical consumption is indispensable. The back light unit is, e.g., classified into two types: one is a one-sided (unilateral) light source lamp in which a tubular light source comprising a cold cathode tube is disposed on one side of a light guide plate, and the other is a both-sided (bilateral) light source lamp in which tubular light sources are disposed on both sides of a light guide plate, respectively. In order to accomplish weight-saving and low electrical consumption, it is advantageous to use the one-sided light source lamp. In a back light unit of such a one-sided light source lamp mode, in order to impart a maximum luminance to an oblique direction of the display surface, a back light unit comprising a light guide plate for a one-sided light source lamp-mode back light, and a prism sheet is proposed, wherein the light guide plate is used for guiding a light from the light source lamp, and the prism sheet is used for changing the direction of the light emitted from the light guide plate into the front direction. In such a constitution, however, the light source lamp is disposed on only one side of the light guide plate. Thereby, in a plate surface perpendicular to the direction along the tube of the light source lamp, when coordinates of emission angle are so defined that the angle of the front direction relative to the panel is 0°, and the side to be disposed the light source lamp is negative (−) direction and the other side is positive (+) direction, luminance is deteriorated in an emission angle range of, for example, −20 to −30°. As a result, high display quality cannot be acquired.

Japanese Patent Application Laid-Open No. 348515/2000 (JP-2000-348515A) proposes a back light unit in which a light-diffusing sheet is interposed between a light guide plate and a prism sheet. However, even in such a unit, the front luminance is remarkably deteriorated, and the foregoing problem has not been solved thoroughly.

Incidentally, in addition to the tubular light source mentioned above, in general, when a light source lamp is locally disposed on one side alone to the display surface, the angle dependence of brightness is often asymmetrical with respect to a front direction in principal. Accordingly, there is caused the factor in impairment of display quality.

It is therefore an object of the present invention to provide a light control sheet for selectively scattering an incident light in the specific angle range as a uniform white scattering light free from interference color, and a process for producing the same.

It is another object of the invention to provide a light control sheet which has an asymmetrically scattering function capable of directing a scattered light to a specific direction even varying the incident direction, and a process for producing the same.

It is still another object of the invention to provide a light control sheet for improving in an angle dependence of brightness even when a light source is locally disposed with respect to a display surface or a light guide plate, and a process for producing the same.

It is a further object of the invention to a light control sheet which is capable of reducing asymmetry in an angle dependence of brightness of a light emitted from a light guide plate in a back light unit comprising a tubular light source on one side thereof, and improving a front luminance of a display surface, as well as a process for producing the same.

It is a still further object of the invention to a process for easily producing a light control sheet at a low cost without using holography technology.

A further object of the invention is to provide a back light unit capable of improving a front luminance characteristic in a display surface of a liquid crystal display apparatus.

### DISCLOSURE OF THE INVENTION

The inventors of the present invention made intensive studies to achieve the above objects and finally found that dispersing a platelike (or plate-like) particle having a given aspect ratio in a transparent resin and sheet-molding of the resin with extrusion molding, press molding or other molding make the plate surface of the particle orientable uniformly along the plane direction of the sheet; and that control over the oriented direction of the particle (particularly a transparent platelike particle) using such an orientation mechanism ensures the followings: selective scattering of a light incident in a specific angle range, uniform white scattering without generation of interference color, and orientation of a scattered light to a certain direction even in varying the incident direction. The present invention was accomplished based on the above findings. Moreover, the inventors also found that composing the platelike particle of a reflective platelike particle and controlling over orientation of the reflective platelike particle realize reduction of asymmetry in an angle dependence of brightness of a light emitted from a light guide plate.

That is, the light control sheet (or light-scattering sheet) of the present invention comprises a transparent resin and a platelike (or leaflike) particle dispersedly oriented in the resin, wherein the direction of the plate surface (or plate surface direction) of the particle is perpendicular to or inclined toward the sheet surface, and the platelike particle comprises at least one member selected from the group consisting of a transparent particle and a reflective particle. Incidentally, the particle is usually oriented in the sheet uniformly. The angle of the plate surface of the particle to the sheet surface (or the angle of the normal line of the plate surface to that of the sheet surface) is usually about 45 to 90° (e.g., about 70 to 90°).

In the case where the platelike particle comprises a transparent particle, the angle of the plate surface of the platelike particle to the sheet surface may be about 70 to 90°, or about 45 to 90°. For example, when the angle is 70 to 90°, the sheet is capable of selectively scattering or directing a light which is incident on the sheet surface from the front direction. When the angle is 45 to 75°, the sheet is capable of selectively scattering a light which is incident on the sheet surface from an inclined direction. In such a light control sheet, the transparent platelike particle may have a mean diameter at the plate surface direction of about 5 to 200 μm, and a ratio of the mean diameter of the particle relative to a mean thickness thereof of about 5 to 1000 (particularly about 40 to 100). Further, the difference between the transparent resin and the transparent platelike particle is usually about 0.01 to 0.2 in refractive index, and the thickness of the sheet is about 50 to 2000 μm. In the light control sheet in which the transparent resin comprises a continuous phase and the transparent platelike particle comprises a dispersed phase, the continuous phase comprising the transparent resin may be selected from a cellulose ester, an olefinic resin, a (meth)acrylic resin, a styrenic resin, a polyester-series resin, a polyamide-series resin, a polycarbonate-series resin, and the like, and the dispersed phase comprising transparent platelike particle may be selected from a mica, a talc, a montmorillonite, and the like. The sheet may further comprise 1 to 100 parts by weight of a plasticizer.

In the case where the platelike particle comprises a reflective particle, the reflective particle may comprise a particle and a metal or metal oxide (e.g., titanium oxide) coating the particle. The reflective platelike particle may have a mean diameter at the plate surface direction of about 5 to 1000 μm, and a thickness of the sheet of about 50 to 1000 μm. In the light control sheet in which the transparent resin comprises a continuous phase and the reflective platelike particle comprises a dispersed phase, the continuous phase comprising the transparent resin may be selected from a cellulose ester, an olefinic resin, a (meth)acrylic resin, a styrenic resin, a polyester-series resin, a polyamide-series resin, a polycarbonate-series resin, and the like, and the dispersed phase comprising reflective platelike particle may be selected from a mica, a talc, a montmorillonite, and the like. In such a light control sheet, a light source is locally disposed to the display surface, and the sheet is useful for a member constituting a back light unit of a display apparatus. The light control sheet is usually available for a back light, which is used for illuminating an object (e.g., a display unit) with a light from a light source (particularly a tubular or point light source), wherein the back light comprises a light source and a light guide plate, and in the light guide plate, a light from the light source is incident on the lateral side (asymmetric position, particularly one lateral side) of the light guide plate and is emitted from the front side of the light guide plate to illuminate the object from behind.

Incidentally, the content of the platelike particle may be about 0.1 to 50 parts by weight relative to 100 parts by weight of the transparent resin.

The present invention includes a method for producing a transparent resin sheet comprising a platelike particle dispersedly oriented to a given direction, which comprises laminating a plurality of transparent resin sheets in which the plate surface of the platelike particle is oriented along the sheet surface, welding these sheets to each other, and slicing the resulting matter in an intersecting direction relative to the laminating direction to obtain the light control sheet.

The light control sheet of the present invention is capable of selectively scattering a light which is incident on the sheet surface from a specific direction range, and can obtain a uniform white scattering light free from any interference color, unlike with a sheet utilizing holography techniques. Further, the light control sheet has an asymmetrically scattering function in which a scattering light is allowed to be oriented at a specific direction even when an incident direction varies.

The light control sheet is usefully employed in combination with a back light unit or liquid crystal display unit for illuminating a display unit from behind. The back light unit comprises, for example, a light guide plate for emitting a light being incident on a lateral side thereof from a front side thereof, a light source disposed at the lateral side of the light guide plate, and the light control sheet interposed between the emitting surface of the light guide plate and the display unit.

Such a light control sheet is realizable without utilizing holography techniques.

### BRIEF DESCRIPTION OF THE DRAWINGS

FIG. 1 is a schematic view showing a cross-section structure of a light control sheet of the present invention.

FIG. 2 is a schematic process drawing for explaining a production process of the present invention.

FIG. 3 is a schematic sectional view of a welded multilayer block for explaining other production process of the present invention.

FIG. 4 is a schematic sectional view showing a back light unit.

FIG. 5 is a microphotograph showing a cross section of the light control sheet obtained in Example 1.

FIG. 6 is a schematic diagram showing an apparatus for measuring an incident angle dependence of scattering intensity in Examples 1 to 10.

FIG. 7 is a graph showing a scattering angle dependence of scattering intensity of the light control sheet obtained in Example 1.

FIG. 8 is a microphotograph showing a cross section of the light control sheet obtained in Example 2.

FIG. 9 is a graph showing a scattering angle dependence of scattering intensity of the light control sheets obtained in Examples 1 to 4 when a light from a light source is incident on the front direction of the sheet.

FIG. 10 is a graph showing a scattering angle dependence of scattering intensity of the light control sheet obtained in Example 4.

FIG. 11 is a graph showing a rectilinear transmittance intensity versus incidence angle of the light control sheets obtained in Examples 5 and 6.

FIG. 12 is a graph showing a scattering angle dependence of scattering intensity of the light control sheets obtained in Examples 7 and 8.

FIG. 13 is a graph showing a scattering angle dependence of scattering intensity of the light control sheet obtained in Example 9.

FIG. 14 is a graph showing a scattering angle dependence of scattering intensity of the light control sheet obtained in Example 10.

FIG. 15 is a microphotograph showing a cross section of the light control sheet obtained in Example 11.

FIG. 16 is a schematic diagram showing an apparatus for measuring an angle dependence of scattering intensity in Examples 11 and 12, and Comparative Example 1.

FIG. 17 is a graph showing a scattering angle dependence of scattering intensity of the light control sheet obtained in Example 11.

FIG. 18 is a graph showing an angle dependence of relative brightness (or relative luminance) in the back light units A and B produced in Example 12.

FIG. 19 is a graph showing an angle dependence of relative brightness (or relative luminance) in the back light units C and D produced in Comparative Example 1.

### BEST MODE FOR CARRYING OUT THE INVENTION

The light control sheet of the present invention comprises a continuous phase comprising a transparent resin, and a dispersed phase comprising a platelike (or plate) particle dispersed in the transparent resin with orienting at a given direction. The platelike particle comprises at least one member selected from a transparent platelike particle and a reflective platelike particle.

[Transparent Resin]

The continuous phase of the light control sheet of the present invention comprises a transparent resin from the viewpoint of transparency, moldability, impact resistance, or others. The transparent resin includes a thermoplastic resin such as a cellulose derivative, an olefinic resin, a halogen-containing resin, a vinyl alcohol-series resin, a vinyl ester-series resin, a (meth)acrylic resin, a styrenic resin, a polyester-series resin, a polyamide-series resin, a polycarbonate-series resin, a polyether-series resin, a polysulfone-series resin, and a thermoplastic elastomer. Incidentally, the transparent resin is often a thermoplastic resin, however, the transparent resin may be a thermosetting resin (e.g., an epoxy resin, an unsaturated polyester resin, a diallylphthalate resin, a silicone resin).

The cellulose derivative includes a cellulose ester (e.g., cellulose acetate, cellulose propionate, cellulose butyrate, and cellulose phthalate), a cellulose carbamate compound, and a cellulose ether compound (e.g. an alkylcellulose, a benzylcellulose, a hydroxyalkylcellulose, a carboxymethylcellulose, and a cyanoethylcellulose). The preferred cellulose derivative includes a cellulose ester (in particular, e.g., cellulose acetate, cellulose propionate, cellulose butyrate, cellulose acetate propionate, and cellulose acetate butyrate).

As the olefinic resin, for example, there may be mentioned a homo- or copolymer of a C₂₋₆olefin [e.g., an ethylene-series resin such as an ethylene-propylene copolymer; a polypropylene-series resin such as a polypropylene, a propylene-ethylene copolymer, and a propylene-butene copolymer; a poly(methylpentene-1)], a copolymer of a C₂₋₆olefin and a copolymerizable monomer [e.g., an ethylene-(meth)acrylic acid copolymer, an ethylene-(meth)acrylate copolymer], and others. The preferred olefinic resin includes a polypropylene-series resin containing propylene at a proportion of not less than 90 mol %, such as a polypropylene and a propylene-ethylene copolymer, a poly(methylpentene-1) and others, and may be a crystalline olefinic resin.

The halogen containing resin includes a vinyl halide-series resin (for example, a homo- or copolymer of vinyl chloride or a fluorine-containing monomer, such as a polyvinyl chloride; and a copolymer of vinyl chloride or a fluorine-containing monomer and a copolymerizable monomer, such as a vinyl chloride-vinyl acetate copolymer, a vinyl chloride-(meth)acrylate copolymer, and a tetrafluoroethylene-ethylene copolymer), a halogenated vinylidene-series resin (e.g., a polyvinylidene chloride-series copolymer, a polyvinylidene fluoride, or a copolymer of a vinyl chloride or a fluorine-containing vinylidene monomer and other monomer(s)), and others.

The derivative of vinyl alcohol-series resin includes a polyvinyl alcohol, an ethylene-vinyl alcohol copolymer, or others. The vinyl ester-series resin includes a homo- or copolymer of a vinyl ester-series monomer (e.g. a polyvinyl acetate), a copolymer of a vinyl ester-series monomer and a copolymerizable monomer (e.g. a vinyl acetate-ethylene copolymer, a vinyl acetate-vinyl chloride copolymer, a vinyl acetate-(meth)acrylate copolymer).

The (meth)acrylic resin includes, for example, a poly(meth)acrylate such as a poly(methyl (meth)acrylate), a methyl methacrylate-(meth)acrylic acid copolymer, a methyl methacrylate-(meth)acrylate-(meth)acrylic acid copolymer, a methyl methacrylate-(meth)acrylate copolymer, and a (meth)acrylate-styrene copolymer (e.g., a MS resin). The preferred (meth)acrylic resin includes a poly(C₁₋₆alkyl (meth)acrylate) and a methyl methacrylate-acrylate copolymer.

As the styrenic resin, there are exemplified a homopolymer or copolymer of a styrenic monomer (e.g., a polystyrene, a styrene-a-methylstyrene copolymer), a copolymer of a styrenic monomer and a copolymerizable monomer [e.g., a styrene-acrylonitrile copolymer (AS resin), a styrene-(meth)acrylate copolymer (e.g., a styrene-methyl methacrylate copolymer), or a styrene-maleic anhydride copolymer].

The polyester-series resin includes an aromatic polyester obtainable from an aromatic dicarboxylic acid (such as terephthalic acid) and an alkylene glycol (a homopolyester, e.g., a polyalkylene terephthalate such as a polyethylene terephthalate, a polypropylene terephthalate and a polybutylene terephthalate, and a polyalkylene naphthalate such as a polyethylene naphthalate and a polybutylene naphthalate; and a copolyester containing an alkylene arylate unit as a main component (e.g., not less than 50 mol %, preferably 75 to 100 mol %, and more preferably 80 to 100 mol %)), an aliphatic polyester obtainable by using an aliphatic dicarboxylic acid such as adipic acid, a polyarylate-series resin, and a liquid-crystalline polyester. The polyester-series resin may be a crystalline polyester-series resin, for example, an aromatic polyester-series resin (e.g., a polyalkylene arylate homopolyester such as a polyalkylene terephthalate and a polyalkylene naphthalate, a copolyester containing not less than 80 mol % of an alkylene arylate unit, a liquid crystalline aromatic polyester). Further, the polyester-series resin may be a noncrystalline polyester-series resin, for example, a copolyester in which at least one member selected from a (poly)oxyalkylene glycol (e.g., diethylene glycol or triethylene glycol), cyclohexane dimethanol, phthalic acid, isophthalic acid, and an aliphatic dicarboxylic acid (e.g., adipic acid) is used as part (e.g., 10 to 80 mol %, preferably 20 to 80 mol %, and more preferably 30 to 75 mol %) of a diol component (C₂₋₄alkylene glycol) and/or an aromatic dicarboxylic acid component (terephthalic acid, naphthalenedicarboxylic acid) in the polyalkylene arylate.

The polyamide-series resin includes an aliphatic polyamide such as a nylon 46, a nylon 6, a nylon 66, a nylon 610, a nylon 612, a nylon 11 and a nylon 12, an aromatic polyamide such as xylylenediamine adipate (MXD-6), and others. The polyamide-series resin is not restricted to a homopolyamide but may be a copolyamide.

The polycarbonate-series resin includes an aromatic polycarbonate based on a bisphenol (e.g. bisphenol A), an aliphatic polycarbonate such as a diethylene glycol bisallyl carbonate, and others.

As the polyether-series resin, there may be exemplified a polyoxyalkylene glycol, a polyoxymethylene (a homo- or copolymer of a polyacetal), a polyetheretherketone. The polysulfone-series resin includes a polysulfone, a polyether sulfone, or others.

The thermoplastic elastomer includes a polyester-series elastomer, a polyolefinic elastomer, a polyamide-series elastomer, a styrenic elastomer, or others.

As the resin for constituting the continuous phase, there may be usually employed a highly transparent and highly thermostable resin. The preferred component constituting the continuous phase includes a cellulose derivative (in particular a cellulose ester), an olefinic resin (e.g., a polypropylene-series resin), a (meth)acrylic resin, a styrenic resin, a polyester-series resin, a polyamide-series resin, a polycarbonate-series resin, or others. Moreover, the resin constituting the continuous phase may be crystalline or noncrystalline.

Incidentally, the resin constituting the continuous phase may be a resin having a melting point or glass transition temperature of about 130° C. to 280° C., preferably about 140° C. to 270° C., and more preferably about 150° C. to 260° C.

[Platelike Particle]

The particle of the light control sheet has a platelike form. The term “platelike form” means a form which has two plate surfaces parallel to each other in a vertical plane and has a length of the creeping direction longer than that of the vertical (or thickness) direction. Therefore, for example, the particle has an indeterminate form in the sight from the plane direction (or surface direction), and the particle has a landscape trapezoid or needle-shaped form in the sight from the lateral direction.

The platelike particle comprises at least one member selected from a transparent platelike particle and a reflective platelike particle.

(Transparent Platelike Particle)

The transparent platelike particle includes, for example, a noncrystalline (or amorphous) inorganic substance such as a glass; a platelike inorganic crystal such as an alumina, an aluminum hydroxide, a mica (a mica such as white mica, bronze mica (or phlogopite) or synthetic mica), a talc, a montmorillonite, and a clay (e.g., kaoline clay, pyrophyllite clay); a polymer including pieces of resin such as a crosslinked acrylic resin, a crosslinked polystyrenic resin, and a crosslinked polysulfone-series resin; or others. These platelike particles may be used singly or in combination. The preferred platelike particle includes a mica, a talc, a montmorillonite, or others. Incidentally, the platelike particle is preferably a fine particle having high transparency. Although, the particle may contain a colored platelike particle, for example, a graphite (natural or synthetic graphite) as far as the light-scattering property is deteriorated. The preferred platelike particle includes, for example, a mica, a talc, a montmorillonite, or others.

Incidentally, the form of the platelike particle is not particularly limited to a specific one, and may be in the form of an amorphous plate, a multiangular (e.g., triangular, square (or rectangular), or hexagonal) plate, an elliptical plate, a circular plate, or other plate. The platelike particle is often in the form of an elliptical plate, particularly a circular plate.

In the transparent platelike particle, the mean diameter of the particle at the surface direction (or plate surface direction) is about 5 to 200 μm, preferably about 7 to 200 μm, and more preferably about 10 to 50 μm (in particular about 20 to 100 μm). When the mean diameter is too small, scatteration is generated even in a range of an incidence angle to be transmitted without scattering the incident light, as a result selectivity of the incidence angle is not obtained. When the mean diameter is too large, the external appearance is deteriorated.

The aspect ratio of the transparent platelike particle (=the mean diameter at the surface direction in the platelike particle/the mean thickness in the particle) is about 5 to 1000, preferably about 10 to 500 (e.g., about 20 to 500), and more preferably about 30 to 200 (in particular about 40 to 100). When the aspect ratio of the particle is too small or the particle is in the form of almost spherical such as elliptical, the orientation is reduced or the light control function (such as an incidence angle-selectively scattering function, or an asymmetrically scattering function) is deteriorated.

In the case where the platelike particle is composed of the transparent platelike particle, the difference in refractive index between the transparent platelike particle and the transparent resin is not less than 0.001 (e.g., about 0.01 to 0.2), preferably about 0.01 to 0.15, and more preferably about 0.05 to 0.15.

(Reflective Platelike Particle)

The reflective platelike particle may be a particle having light reflectivity in a platelike particle itself (for example, an aluminum which may be given surface treatment), or a particle imparted light reflectivity to a platelike particle. The reflective platelike particle usually comprises a platelike particle exemplified in the paragraph of the transparent platelike particle, and a component for coating the platelike particle and imparting light reflectivity (in particular at least one member selected from a metal and a metal oxide).

As the metal and the metal oxide, for example, there may be mentioned various components showing metallic luster, e.g., a metal such as titanium, zirconium and aluminum, and a metal oxide such as titanium oxide, zirconium oxide and aluminum oxide.

The coating amount of the metal or metal oxide may for example be about 0.1 to 50 parts by weight, preferably about 1 to 50 parts by weight (e.g., about 5 to 50 parts by weight), and more preferably about 5 to 30 parts by weight relative to 100 parts by weight of the platelike particle.

In the reflective platelike particle, the mean diameter of the particle at the surface direction is, for example, about 5 to 1000 μm (e.g., about 5 to 500 μm), preferably about 10 to 500 μm (e.g., about 10 to 300 μm), and more preferably about 20 to 300 μm (e.g., about 20 to 200 μm). When the mean diameter is too small, not only reflectivity but also scatteration is expressed, as a result directivity of the outgoing (or emitting) light is reduced and not obtains high display quality. When the mean diameter is too large, the external appearance is deteriorated.

The aspect ratio of the reflective platelike particle (=the mean diameter of the surface direction in the platelike particle/the mean thickness in the particle) is about 5 to 10000, preferably about 10 to 5000, and more preferably about 10 to 3000. When the aspect ratio of the particle is too small or the form thereof is almost spherical such as elliptical, the orientation is reduced or high display quality cannot be obtained. When the aspect ratio is too large, the external appearance is deteriorated.

The proportion of the platelike particle may be usually selected within such a range that high light-control is realizable. For example, the proportion of the platelike particle is about 0.1 to 100 parts by weight, and preferably about 0.2 to 50 parts by weight relative to 100 parts by weight of the transparent resin.

In the present invention, the transparent platelike particle and the reflective platelike particle may be used in combination, and either of these particles is usually employed. In the case using the transparent platelike particle, selectivity of an incident light can be improved. For example, an incident light in a specific angle range can be scattered selectively and as a uniform white scattering light free from interference color, or a scattering light can be oriented at a specific direction even when an incident direction varies. In the case using the reflective platelike particle, since an angle dependence of brightness can be improved even when a light source is unevenly disposed with respect to a display surface or a light guide plate, such a sheet is, for example, suitable for a one-sided light source lamp-mode back light unit comprising a tubular light source.

The proportion of the transparent platelike particle may be selected depending on a desirable light-scattering property, and for example, is about 1 to 50 parts by weight, preferably about 1 to 30 parts by weight, and more preferably about 1 to 20 parts by weight (e.g., about 1 to 10 parts by weight) relative to 100 parts by weight of the transparent resin.

The proportion of the reflective platelike particle may be selected depending on a desirable light-control property, and for example, is about 0.1 to 50 parts by weight, preferably about 0.1 to 30 parts by weight (e.g., about 0.1 to 20 parts by weight), and more preferably about 0.2 to 10 parts by weight (e.g., about 0.2 to 5 parts by weight) relative to 100 parts by weight of the transparent resin.

[Additive Component]

If necessary, the above-mentioned resin component may be modified (e.g., rubber-modified) or plasticized (e.g., plasticized with addition of a plasticizer for a plasticized vinyl chloride-series resin, or plasticized by polymerization with a soft component), or to the transparent resin may be added various components. In particular, such a modification or plasticization is effective in the case using the transparent platelike particle as a platelike particle. For example, a plasticizer may be added in order to improve moldability, mechanical strength, or others. For instance, as the plasticizer for improving moldability or flexibility of a cellulose ester, there may be mentioned a phthalate ester-series plasticizer [e.g., a diC₁₋₁₂alkyl phthalate such as DEP (diethyl phthalate), DBP (dibutyl phthalate), DOP (dioctyl phthalate), and di-2-ethylhexyl phthalate], a aliphatic polycarboxylate ester [e.g., a C₂₋₁₂alkyl C₆₋₁₂alkane-carboxylate such as diethyl adipate, dibutyl adipate, and dioctyl sebacate], a phosphate ester-series plasticizer [e.g., TPP (triphenyl phosphate), tributyl phosphate], a carboxylate ester of a polyhydric alcohol [e.g., an acetate ester of a polyhydric alcohol such as ethylene glycol diacetate, diethylene glycol diacetate, propylene glycol diacetate, and triacetine], and others. These plasticizers may be used singly or in combination.

The amount to be added of the plasticizer relative to 00 parts by weight of the transparent resin may for example be selected within a range of about 1 to 100 parts by weight and preferably about 5 to 75 parts by weight, depending on the species of the transparent resin.

In order to accessorily control or increase light scattering property, the light control sheet of the present invention may contain a non-platelike particle (e.g., spherical, elliptical, or amorphous particle) in addition to the transparent platelike particle. Such a non-platelike particle includes an inorganic particle (e.g., calcium carbonate, titanium oxide), an organic particle (e.g., a crosslinked methyl methacrylate polymer, a crosslinked polystyrene), or others. The content of the non-platelike particle is usually smaller than that of the platelike particle, and may for example be about 0.1 to 10 parts by weight relative to 100 parts by weight of the transparent resin.

Moreover, the light control sheet may comprise a stabilizer (an ultraviolet absorber (or ultraviolet ray absorbing agent), an antioxidant, a heat stabilizer), an antistatic agent, a flame retardant, a coloring agent, a dispersing agent (or dispersant), or others.

[Structure of Sheet]

FIG. 1 is a schematic view showing a cross-section structure of a light control sheet of the present invention. As shown in FIG. 1, a light control sheet 1 comprises a transparent resin 2, and a platelike particle 3 dispersed in the transparent resin. The platelike particle is uniformly oriented in the sheet (or transparent resin matrix). Then, the direction of the plate surface of the platelike particle 3 is perpendicular to or inclined at a given angle θ to the plane of the sheet 1. The angle θ of the plate surface of the particle 3 to the plane of the sheet 1 (or the angle of the normal line of the plate surface to the normal line of the sheet surface (or sheet plane)) may for example be selected within a range of about 45 to 90° (preferably about 60 to 90°, and more preferably about 70 to 90°) depending on the light-scattering function.

Such a light control sheet has various excellent properties with respect to an incident light.

For example, a light control sheet using a transparent platelike particle has an incidence angle-selectively scattering function in which an incident light in a specific angle range is selectively scattered, or a function in which a scattering light is allowed to be oriented at a specific direction even when an incident direction varies (or an asymmetrically scattering function). In this light control sheet, the angel θ may be about 70 to 90° (e.g., about 75 to 90°), and particularly about 80 to 90° (e.g., about 85 to 90°) or about 70 to 89° (e.g., about 75 to 89°), or may be about 45 to 75° (e.g., about 45 to 70°).

As an example of relationship between the function of the light control sheet and the angel θ, in the case where a specific light scattering function is effectively expressed to a light which is incident on the front direction (the perpendicular direction relative to the sheet surface), the angel θ is usually selected within a range from about 70 to 90° (preferably about 75 to 90°). More specifically, for example, in the case where only incident light in an angle range around a front face of a sheet (e.g., in a range of ±30° relative to a front direction) is selectively scattered (frontally incident-selective scattering), or in the case where a light is scattered with directional orientation to a front direction by imparting a function (asymmetric scattering function) in which a scattering light is directed or focused to a specific direction even in altering the incident direction, the angel θ is, for example, about 80 to 90° (preferably 85 to 90°). Moreover, a light being incident on the front direction is shifted to a specific direction (e.g., shifted within an angle range of 5 to 30°, particularly 10 to 30°) to scatter the light (axis-shifting scattering), the angel θ is, for example, about 70 to 89° (preferably about 75 to 89°).

Further, in the case of selective scattering to a specific oblique incident light [e.g., alight which comes from at an angle of 10 to 80° (particularly 20 to 80°) with respect to a front direction] (selective scattering of oblique incidence), the angel θ is, for example, about 45 to 75° (preferably about 45 to 70°).

The light control sheet containing a reflective platelike particle has a function in which part of an incident light is reflected (or changed in the angle) to a counter direction to the incident direction. Therefore, the light control sheet is attached to a back light unit to reduce asymmetric property in an angle dependence of brightness of a light emitted from the light guide plate, and has a function for improving display quality.

The arrangement form of the platelike particle in the light control sheet is not particularly limited to a specific one. For example, in the platelike particle, the position of the center of gravity may be randomly arranged in the transparent resin sheet, or may be dispersed regularly or irregularly.

The thickness of the light control sheet of the present invention may for example be selected within a range from 10 to 3000 μm, and preferably 30 to 2000 μm.

The thickness of the light control sheet containing the transparent platelike particle is, for example, about 50 to 2000 μm, preferably about 80 to 1000 μm, and more preferably about 100 to 800 μm, in order to realize high selectivity of an incidence angle.

The thickness of the light control sheet containing the reflective platelike particle is, for example, about 50 to 1000 μm, preferably about 50 to 800 atm, and more preferably about 70 to 500 μm (e.g., about 70 to 300 μm), in order to realize high light-controlling characteristic.

[Production Process of Light Control Sheet]

The process for producing the light control sheet of the present invention is not particularly limited to a specific one, and may include various methods. However, the sheet of the present invention, differently from conventional light control sheets, has a significant advantage that is producible without utilizing holography techniques. As an embodiment of such a production process, there may be mentioned, for example, a method which comprises laminating a plurality of transparent resin sheets (primary sheets) in which the plate surface of the platelike particle is oriented and disposed along the sheet surface, welding these sheets to each other, and slicing or cutting the resulting matter to a given thickness in an intersecting direction relative to the laminating direction. Incidentally, the laminated surface (or laminated plane) of the multilayer mass in the plurality of the primary sheets may be perpendicular to the slicing plane, or may be inclined toward the slicing plane.

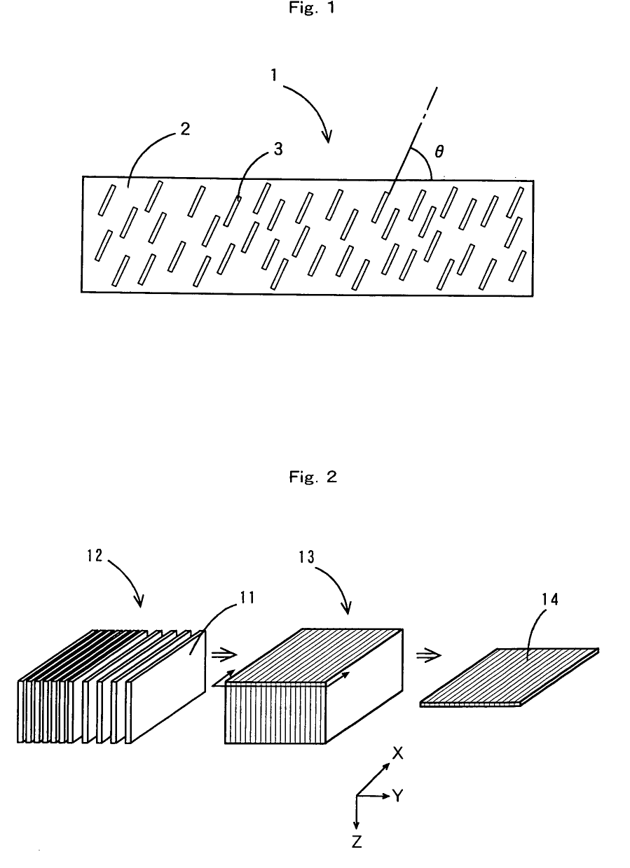

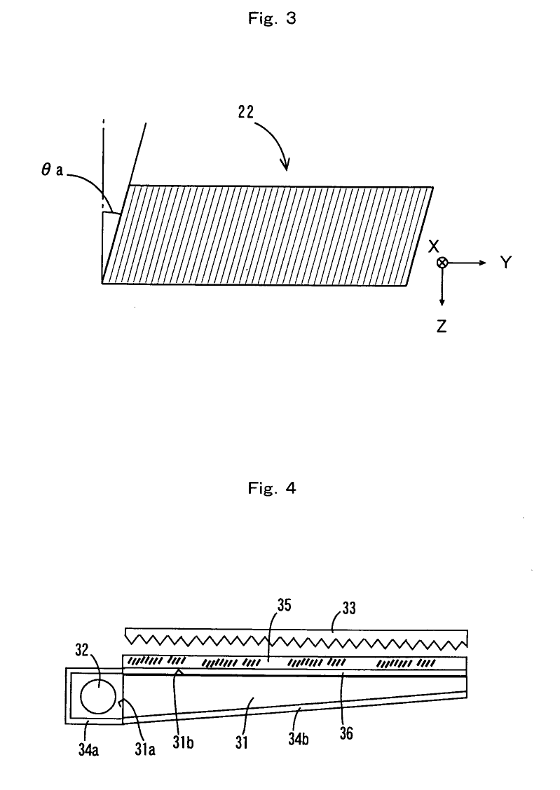

FIG. 2 is a schematic process drawing for explaining a production process of the present invention. In this embodiment, a plurality of primary sheets 11 comprising a transparent resin and a platelike particle are laminated (or layered) so that the laminated surface is directed to almost vertical direction relative to the horizontal plane, to form a multilayer mass 12, and the multilayer mass 12 is heated and welded with substantially maintaining the orientation of the platelike particle to form a unified welded multilayer block 13. The multilayer block is sliced toward a direction perpendicular to the laminated surface of the welded multilayer block at a given thickness to prepare a light control sheet 14.

In such a method, the light control sheet 14 in which the plate surface of the platelike particle is oriented in an angle of almost 90° to the sheet surface can be obtained.

FIG. 3 is a schematic sectional view of a multilayer mass for explaining other production process of the present invention. In this embodiment, in a multilayer mass 22, a plurality of primary sheets is laminated (or layered) with inclining by an angle of θa. That is, in a multilayer mass formed with a plurality of primary sheets, the side surface is inclined by an angle of θa, and a welded multilayer block is prepared by heating the multilayer mass with maintaining the angle of inclination in the both sides of the multilayer mass and orientation state of the platelike particle.

Thus, in the case preparing a welded multilayer block by inclining the side surface of the block-like multilayer mass, a light control sheet which differs in the orientation angle of a platelike particle to the sheet surface can be easily produced by slicing the welded multilayer block in a direction of the upper or lower face. Moreover, based on the angle of inclination in the lateral side of the welded multilayer block, the orientation angle of the platelike particle to the sheet surface can be controlled easily.

Incidentally, in the sheet-forming method such as extrusion molding, the primary sheet may be laminated continuously or intermittently in a sequential order with the use of folding, extrusion laminating, or others. In such a method, a welded multilayer block can be obtained along with lamination.

It is sufficient that the slicing or cutting direction is a direction intersecting with the laminated surface of the primary sheet. When the direction of the laminated surface (the plane of the primary sheet), the laminating direction, and the thickness direction perpendicular to or intersecting with the laminating direction are taken as X-axial direction, Y-axial direction, and Z-axial direction, respectively, the welded multilayer block is usually sliced along a plane in an angle range of about 15° (preferably about 10°) with a central focus on the X-Y plane (in particular substantially X-Y plane) in many cases.

Incidentally, the primary sheet can be produced with various methods by utilizing a manner in which the action of shearing force brings the platelike particle into orientation to the sheet surface direction accompanying with the sheet forming. For example, a primary sheet may be produced by melt-kneading a transparent resin and a platelike particle, and extrusion molding the kneaded product into a sheet form. Moreover, a primary sheet may be also formed by kneading a transparent resin and a platelike particle, and pressing the molten product with or without heating. Further, a primary sheet may be also formed by other methods, for example, a calender processing method, an injection molding method, and a cast method which comprises forming by flow casting a dope containing a solvent. In such a sheet-forming method, the platelike particle is oriented so that the plane thereof is taken along the sheet surface by shearing force accompanying with injection, extrusion, or pressing.

The sheet of the present invention has a variety of excellent properties or characteristics to an incident light, and is available for various optical application such as a plane light source apparatus or a liquid crystal display apparatus.

In particular, the sheet using a transparent platelike particle has a function that selectively scatters an incident light in a specific angle range (an incidence angle-selectively scattering function), or an asymmetrically scattering function that ensures orientation of a scattering light to a specific direction even in the case varying the incident direction. Such a sheet is useful for imparting the light scattering function to the light transmitted through the sheet. Therefore, such a light control sheet is available for various application in which light scattering functions are required, for example, a light scatting sheet which is disposed in front of a liquid crystal panel (display surface) or interposed between a liquid crystal panel and a light source, in a display apparatus such as a liquid crystal display apparatus or device (a reflection mode or transmission mode liquid crystal display apparatus or device).

Moreover, a sheet using a reflective platelike particle reflects part of an incident light into a counter direction relative to the incident direction with changing the angle to improve asymmetry in an angle dependence of brightness in the emitting surface of the light guide plate or the display surface, even when a light source (particularly a tubular light source) is locally disposed to a light guide plate or a display surface, and the front luminance can be improved. Therefore, in a back light unit for symmetrizing an angle dependence of brightness or in a display apparatus such as a liquid crystal display apparatus (a transmission mode liquid crystal display apparatus), such a light control sheet is available as a light-functional sheet interposed between an emitting surface of a light guide plate and a display unit (such as a liquid crystal display unit or a liquid crystal panel).

[Back Light Unit]

The light control sheet of the present invention (in particular a sheet using a reflective platelike particle) is useful for a sheet for illuminating an object by a light from a light source (particularly a tubular light source or a point light source), in particular for a sheet used in combination with a back light unit in which a light source is locally (or noncentrally) disposed to a display surface or light guide plate. In the back light unit, the structure of the back light unit is not particularly limited to a specific one as far as the back light unit has a back light in which a light source lamp is locally disposed to one side of a display surface or light guide plate. Incidentally, examples of the tubular light source include a cold cathode tube, and examples of the point light source include a LED (light emitting diode).

FIG. 4 is a schematic sectional view showing a back light unit. In this embodiment, the back light unit comprises a light guide plate 31, with a wedge-shaped cross section, having an incidence surface 31a at one lateral side and an emitting surface 31b at the front side, a tubular light source (e.g., a cold cathode tube) 32 disposed in one lateral side (incidence surface side) of the light guide plate, and a prism sheet 33 which is disposed in the side of the emitting surface 31b of the light guide plate 31 and has a prism sequence with a triangle-shaped cross section. In the lateral side of the tubular light source 32, a reflection frame 34a surrounding the tubular light source is disposed, and in the reverse surface of the light guide plate 31, a reflecting plate 34b is disposed.

In such a back light unit, a light from the tubular light source 32 may be incident on the lateral side 31a of the light guide plate 31, emit from the emitting surface (front side) 31b of the light guide plate 31, and illuminate a display unit as an object (e.g., a liquid crystal display unit, not shown) from a back thereof, wherein the display unit is disposed in the front side of the emitting surface 31b of the light guide plate 31. However, since the tubular light source 32 is located in one lateral side of the light guide plate 31, a symmetric angle dependence of brightness is deteriorated relative to the front direction of the emitting surface 31b of the light guide plate 31 and that of the display surface of the display unit.

Therefore, in the embodiment shown in FIG. 4, the light control sheet 35 is laminated on the emitting surface 31b of the light guide plate 31 through a transparent adhesive layer 36. In this embodiment, the reflective platelike particle in the light control sheet 35, in which the direction of the plate surface is almost perpendicular to the sheet surface, is oriented or directed, or the plate surface of the reflective platelike particle is oriented in an inclined direction with respect to a direction from the emitting surface 31b side to the display unit side with increasing a distance from the tubular light source 32 (in FIG. 4, inclines in a upper right direction) (that is, the emitting surface 31b side of the particle rather than the display unit side thereof inclines to the tubular light source 32 side). In such a back light unit, since part of the light from the emitting surface 31b of the light guide plate 31 can be reflected by the reflective platelike particle, the angle dependence of brightness can be symmetrized relative to the front direction of the emitting surface 31b of the light guide plate 31 and that of the display surface of the display unit, and also can inhibit from luminance down slide at a specific angle, and thereby the display unit can be uniformly illuminated. Therefore, the characteristic of the front luminance in the display unit is improved, and the display quality is enhanced.

In particular, the back light unit is advantageously used in combination with a liquid crystal display unit as a display unit. Therefore, the present invention also discloses a liquid crystal display apparatus comprising the liquid crystal display unit and the back light unit.

Incidentally, in the back light unit, a prism sheet is not necessarily required. In the case using a prism sheet, a single or a plurality of prism sheet(s) may be used. A plurality of prism sheets may be disposed so that the prism sequences are crossed each other. Further, the prism sheet may be disposed so that the prism sequences are oriented to the display unit side and/or the light guide plate side. Furthermore, if necessary, a light-diffusing plate or a light-diffusing sheet may be disposed in a light path between the light guide plate and the display unit.

The light control sheet may be attached to a suitable site in the back light unit, and the attachment site is not particularly limited to a specific one. For example, in the above-mentioned embodiment, the light control sheet may be disposed or attached in front of the prism sheet, or may be held tight between the prism sheet and the light guide plate, or may be laminated with a light-diffusing plate. Incidentally, in order to reduce a loss due to reflection, the light control sheet may be stuck with other member through a transparent adhesive layer.

### Industrial Applicability

According to the present invention, since the transparent platelike particle is dispersed in a specific structure, an incident light in a specific angle range can be scattered selectively and as a uniform white scattering light free from interference color. Moreover, the angle of the incidence light can be improved in selectivity, and directivity can be imparted to the scattering light.

Further, since the reflective platelike particle is oriented and dispersed in the continuous phase of the transparent resin, the angle dependence of brightness can be improved even when the light source is locally disposed to the display surface or the light guide plate. In particular, even in a back light unit comprising a light source (tubular or point light source) at one side, asymmetric property in the angle dependence of brightness of a light emitted from the light guide plate can be reduced, and the front luminance of the display surface can be improved. Therefore, such a light control sheet of the present invention is useful for a component member of a back light unit for improving a front luminance characteristic of a display surface of a liquid crystal display apparatus.

Furthermore, the present invention ensures a convenient and inexpensive production of a light control sheet without using holography techniques.

### EXAMPLES

The following examples are intended to describe this invention in further detail and should by no means be interpreted as defining the scope of the invention.

### Example 1

<Production of Primary Sheet>

With 100 parts by weight of a cellulose acetate flake (manufactured by Daicel Chemical Industries, Ltd., acetylation degree of 53%), 50 parts by weight of diethyl phthalate and 1 part by weight of a stabilizer were blended to give an original flake of a transparent resin sheet, wherein the stabilizer was a mixture containing “PHOSPHITE PEP36” (manufactured by Asahi Denka Co., Ltd.), an epoxidized soybean oil “DAIMAC S-300K” (manufactured by Daicel Chemical Industries, Ltd.) and an antioxidant “ANTI-OX L” (manufactured by NOF Corporation) at a proportion of 4:4:2 (weight ratio). To this original flake was added 3 parts by weight of a transparent mica fine particle (“PDM10B” manufactured by Topy Industries, Ltd., mean diameter at surface direction: 12 μm, thickness: 0.2 μm), and the mixture was heated at 235° C., kneaded, and solidified in a cold water to cut into a pellet. The pellet was dried at 90° C. for 2 hours, then heated at 180° C., kneaded, and extruded into a sheet having 10 cm of width and 0.5 mm of thickness to form a primary sheet. The observation by a section photograph of this primary sheet revealed that the platelike particle was orientationally dispersed along the sheet surface. Hereinafter, as a coordinate system, an extrusion direction of a primary sheet is taken as X-axial direction.

<Block Fabrication and Slicing>

This primary sheet was cut off by a length of 30 cm along the X-axial direction to make strips, and as shown in FIG. 2, 400 pieces of the strip-like primary sheets 11 were laminated (or layered) in the vertical direction. The multilayer mass 12 was heated to 80° C. with pressing the both sides to weld the primary sheets of the multilayer mass each other, and a welded multilayer block (block) 13 was produced. Incidentally, as a coordinate system, the laminating direction of this block 13 and the height direction thereof are defined as Y-axial direction and Z-axial direction, respectively. The size of thus obtained block was 30 cm in the X-axial direction, 20 cm in the Y-axial direction, and 10 cm in the Z-axial direction. This block 13 was cut into slices having a thickness of 0.7 mm along the X-axial direction (X-Y plane) so that the Z-axial direction was defined as the thickness direction to obtain a light control sheet 14 having a length of 30 cm and a width of 20 cm. Incidentally, FIG. 2 shows the schematic diagram expressing the production process of the primary sheet and block, and the light control sheet, as well as the coordinate system.

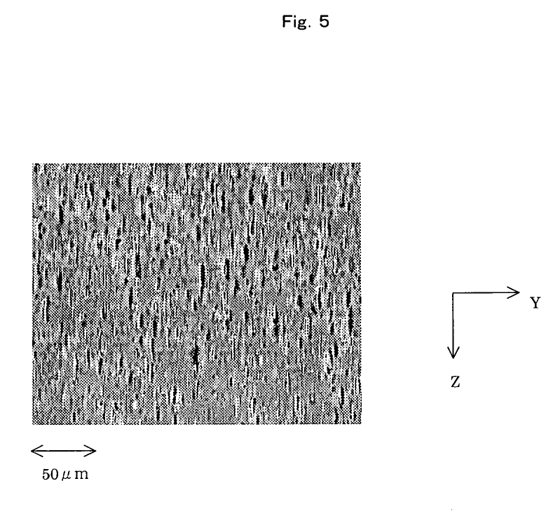

FIG. 5 shows a cross sectional view (photomicrograph) along the Y-Z plane of thus obtained light control sheet 14. In the sheet, the mica fine particle was uniformly oriented so that the plate surface was directed to the Y-axial direction, and the angle of plate surface of the mica fine particle to the sheet surface was substantially 90°.

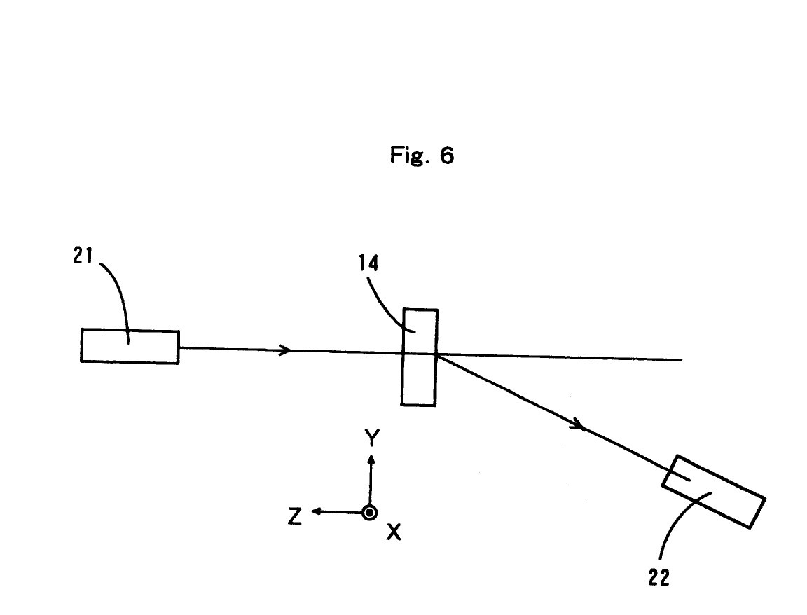

As shown in FIG. 6, this light control sheet 14 was attached to a light scattering measurement apparatus (“Goniophotometer” manufactured by Murakami Color Research Laboratory) so that the X-axis became a rotation axis, and a rectilinear white light source 21 was incident on the front face. An angle of a light-receiving member 22 was varied around the X-axis as a rotation axis to measure the scattering intensity versus scattering angle.

Subsequently, qualifying the X-axis as an axis, the incident direction of the incident light source was rotated clockwise at 10° from the front face, and in the same manner, the scattering intensity versus angle was measured at an incidence angle of 10°. In the same way, the incidence angle of the incident light source was rotated at 20° or 30° from the front face qualifying the X-axis as an axis, and the scattering intensity versus angle was measured at an incidence angle of 20° or 30° in the same manner.

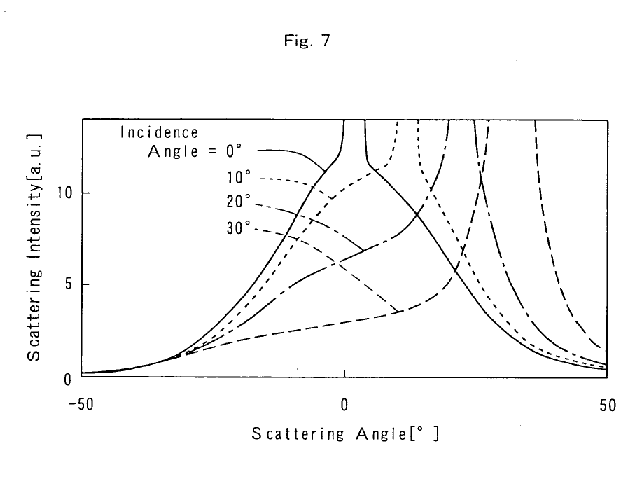

The measurement results are shown in FIG. 7. In FIG. 7, the scattering angle of 0° means a normal direction relative to the sheet surface. As apparent from the figure, the scattered light is always allowed to orient to a direction being the scattering angle of 0° by asymmetric scattering even if the incidence angle varies. That is, it is determined that the sheet has a light condensing (or focusing) action.

### Example 2

The primary sheet prepared in Example 1 was cut off by a length of 30 cm along the X-axial direction to make strip-like primary sheets. As shown in FIG. 3, 400 pieces of the strip-like primary sheets were laminated (or layered) so that the top of the primary sheets was tilted in a lateral direction at an angle θa of 10° to the perpendicular line. The multilayer mass was heated to 180° C. with pressing the both sides thereof to weld the primary sheets of the multilayer mass each other, and a block of which the both sides were inclined by an angle of 10° was produced. This block was sliced to a thickness of 0.6 mm along the X-axial direction (X-Y plane) so that the Z-axial direction was defined as the thickness direction to obtain a light control sheet.

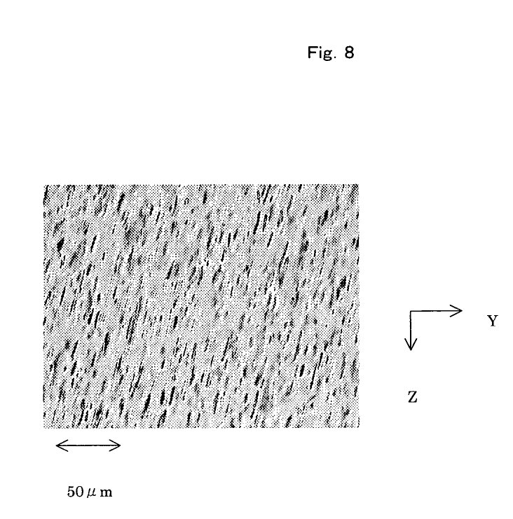

FIG. 8 shows a cross sectional view along the Y-Z plane of this light control sheet (photomicrograph). As shown in this figure, the mica fine particle in the sheet was uniformly oriented so that the angle of the plate surface to the sheet surface was 80°.

### Example 3

A light control sheet 0.8 mm thick was obtained in the same manner as in Example 2 except that the angle of inclination θa of the block lateral side was taken as 15°. The observation of the section along the Y-Z plane in this light control sheet revealed that the mica fine particle in the sheet was uniformly oriented so that the angle of the normal line of the plate surface to the normal line of the sheet surface was 75°.

### Example 4

A light control sheet 0.6 mm thick was obtained in the same manner as in Example 2 except that the angle of inclination θa of the block lateral side was taken as 20°. The observation of the section along the Y-Z plane in this light control sheet revealed that the mica fine particle in the sheet was uniformly oriented so that the angle of the normal line of the plate surface to the normal line of the sheet surface was 70°.

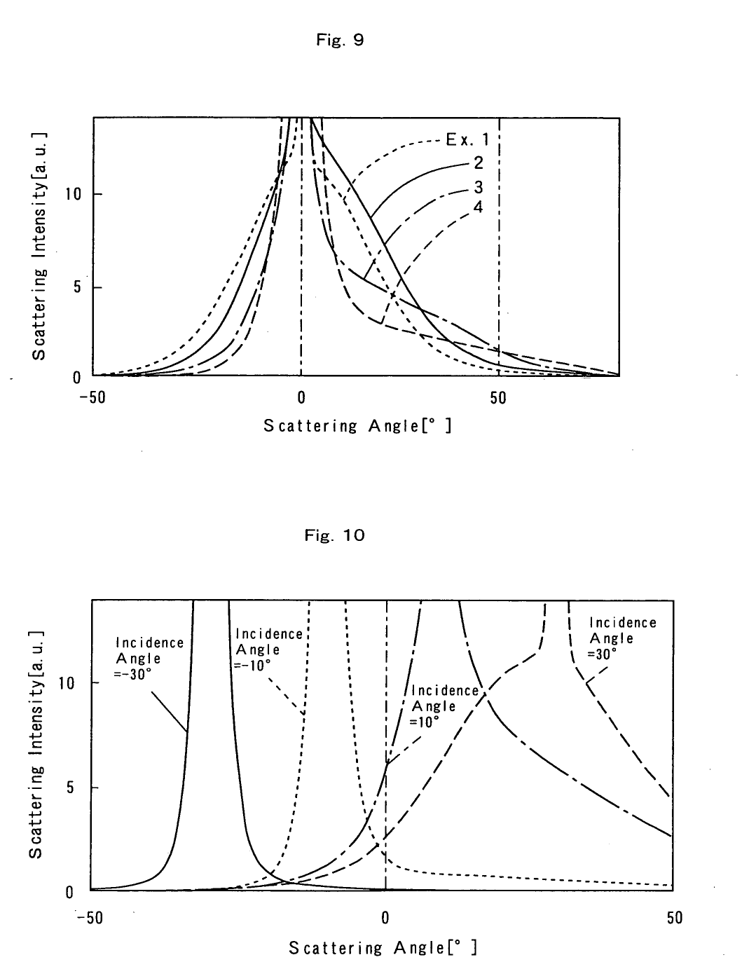

Regarding each of light control sheets obtained in Examples 1 to 4, the scattering intensity versus scattering angle to a front incident light source was measured with the use of a light scattering measurement apparatus shown in FIG. 6. The results are shown in FIG. 9. In the light control sheets of Examples 3 and 4, an asymmetric scattering function is also expressed in the front incidence by the inclined orientation of the platelike particle, and it is determined that the both sheets have a light condensing (or focusing) action.

The light control sheet obtained in Example 4 was attached to a light scattering measurement apparatus shown in FIG. 6 so that the X-axis became a rotation axis, and qualifying the X-axis as an axis, the incident light source was rotated at −30°, −10°, 10°, or 30° from the front face, and the scattering intensity versus scattering angle was measured at each incidence angle. The results are shown in FIG. 10.

As apparent from FIG. 10, in the incidence angle not more than 0°, scattering does not occur, or very weakly occurs. On the other hand, the incident light in the incidence angle not less than 0° is scattered strongly, and a selective scattering to an incidence angle is recognized.

### Example 5

Three (3) parts by weight of a transparent mica fine particle (“PDM10B” manufactured by Topy Industries, Ltd., mean diameter at surface direction: 12 μm, thickness: 0.2 μm) was impregnated with 17 parts by weight of n-butyl adipate, 17 parts by weight of diethyl phthalate, and 1 part by weight of a stabilizer [a mixture containing “AO60” (manufactured by Asahi Denka Co., Ltd.) and “Celloxide 2021” (manufactured by Daicel Chemical Industries, Ltd.) at a proportion of 6:4 (weight ratio)], and the resulting matter was mixed with 66 parts by weight of a cellulose acetate propionate (“482-20” manufactured by Eastman Chemical Company), heated at 160° C., and kneaded together. The kneaded product was solidified in a cold water to cut into a pellet. The pellet was dried at 60° C. for 2 hours, then heated at 160° C., kneaded, and extruded into a sheet having 10 cm width and 0.5 mm thickness to form a primary sheet. Using the primary sheet, a light control sheet 0.33 mm thick, in which the angle of the plate surface of the mica fine particle to the sheet surface was 90°, was obtained in the same manner as in Example 1.

### Example 6

In the same manner as in Example 5, a light control sheet 0.55 mm thick, in which the angle of the plate surface of the mica particle to the sheet surface was 90°, was obtained.

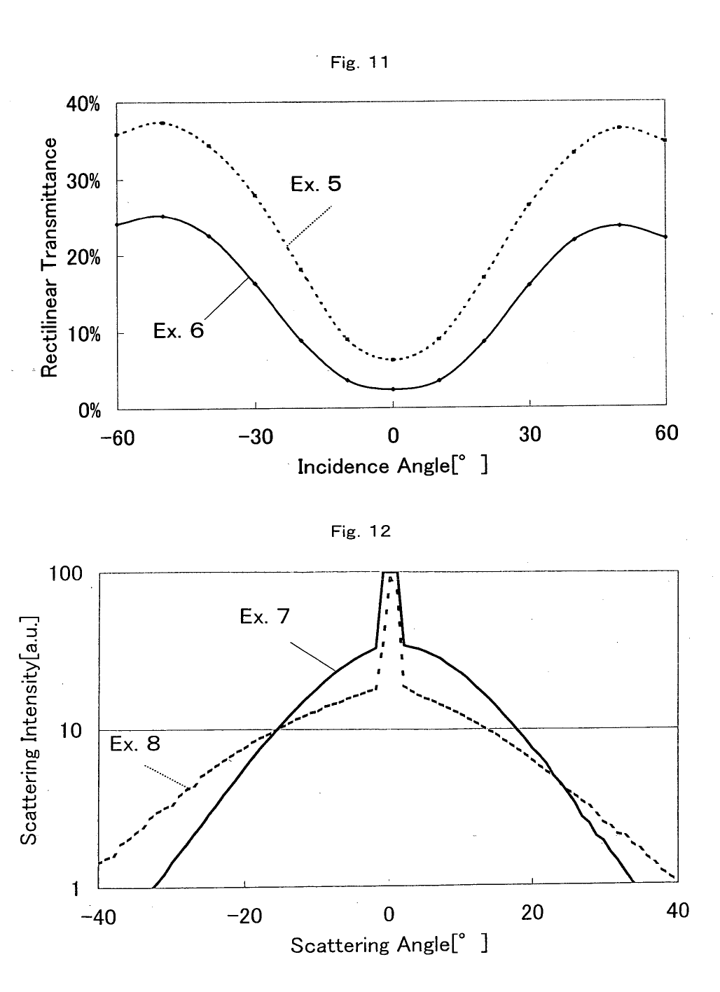

The light control sheets obtained in Examples 5 and 6, was attached to a light scattering measurement apparatus as shown in FIG. 6 so that the X-axis became a rotation axis, and the light-receiving member 22 was fixed to 0°, and an intensity of a rectilinear transmitted light without scattering (rectilinear transmittance intensity) was measured. Further, the relationship of the rectilinear transmittance intensity relative to the incidence angle in a range from −60° to 60° was measured by varying the incident direction of the incident light source with rotating the light control sheet 14. The results are shown in FIG. 11. Incidentally, in FIG. 11, the rectilinear transmittance intensity is represented as a rectilinear transmittance (a value determined from normalization of a rectilinear transmittance intensity by a rectilinear transmittance intensity of a transparent sheet).

As apparent from FIG. 11, the light control sheet of the present invention has an incidence angle selectivity varying a scattering intensity (rectilinear transmittance) depending on an incidence angle. Further, in each light control sheet, strong scattering occurs around an incidence angle of 0°, and the rectilinear transmittance becomes lower. That is, it is recognized that the light control sheet of the present invention scatters a light strongly when the light comes along the plate surface of the platelike particle.

### Example 7

In the same manner as in Example 5, a light control sheet 0.4 mm thick, in which the angle of the plate surface of the mica particle to the sheet surface was 90°, was obtained.

### Example 8

A light control sheet 0.65 mm thick, in which the angle of the plate surface of the mica particle to the sheet surface was 90°, was obtained in the same manner as in Example 5 except for using a transparent mica fine particle (“PDM-9WAB” manufactured by Topy Industries, Ltd., mean diameter at surface direction: 12 μm, thickness: 0.35 μm) as a transparent platelike particle.

As shown in FIG. 6, each of the light control sheets obtained in Examples 7 and 8 was attached to a light scattering measurement apparatus so that the X-axis became a rotation axis, and a rectilinear white light source 21 was entered from the front face. An angle of a light-receiving member 22 was varied around the X-axis as a rotation axis to measure the scattering intensity versus scattering angle. The results are shown in FIG. 12.

As apparent from FIG. 12, it is recognized that the thinner thickness of the platelike particle (the larger aspect ratio) inhibits more effectively the spread in the bottom of the scattering intensity at a wide angle (e.g., not less than 30°) and orients a light to the front direction.

### Example 9

A light control sheet 0.6 mm thick, in which the angle of the plate surface of the mica particle to the sheet surface was 75°, was obtained in the same manner as in Example 3 except for using a transparent mica fine particle (“PDM-05B” manufactured by Topy Industries, Ltd., mean diameter at surface direction: 5.5 μm, thickness: about 0.2 μm) as a transparent platelike particle.

### Example 10

A light control sheet 0.78 mm thick, in which the angle of the plate surface of the mica particle to the sheet surface was 75°, was obtained in the same manner as in Example 3 except for using a transparent mica fine particle (“PDM-20B” manufactured by Topy Industries, Ltd., mean diameter at surface direction: 20 μm, thickness: about 0.3 μm) as a transparent platelike particle.

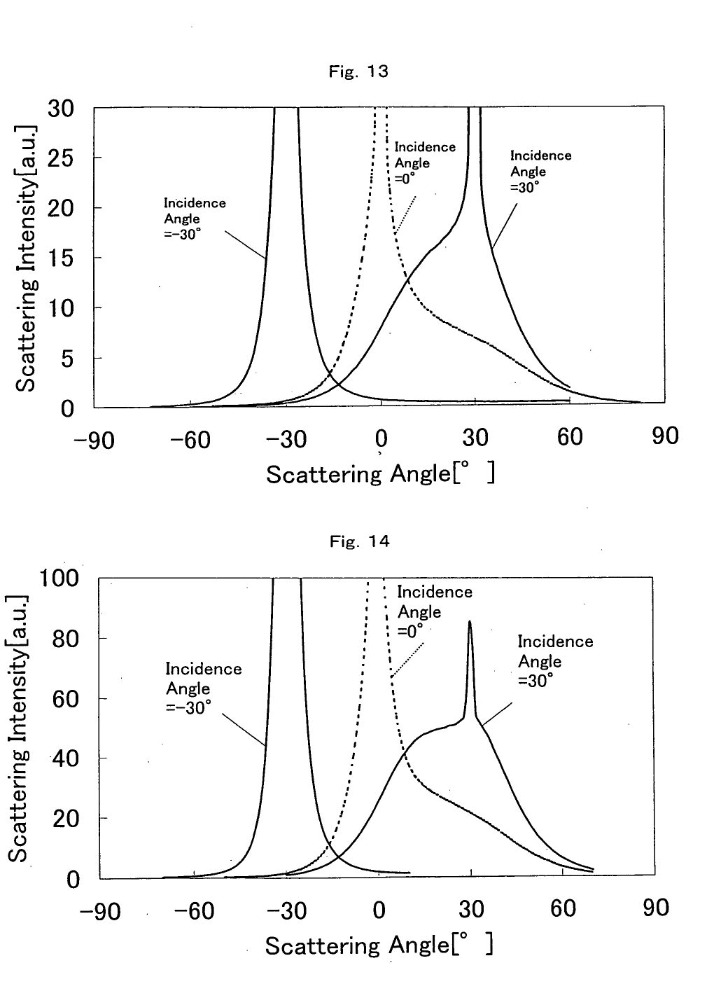

Each of the light control sheets obtained in Examples 9 and 10 was attached to a light scattering measurement apparatus shown in FIG. 6 so that the X-axis became a rotation axis, and qualifying the X-axis as an axis, the incident light source was rotated at −30°, −10°, 10°, or 30° from the front face, and the scattering intensity versus angle was measured at each incidence angle. The results of the light control sheets obtained in Examples 9 and 10 are shown in FIGS. 13 and 14, respectively.

As apparent from FIGS. 13 and 14, a selective scattering to an incidence angle and asymmetric scattering are recognized similar to FIG. 10.

### Example 11

<Production of Primary Sheet>

To 100 parts by weight of a cellulose acetate propionate (“307E-09” manufactured by Eastman Chemical Company) was added 0.7 part by weight of a synthetic mica fine particle coated with titanium oxide (the mean diameter at surface direction: 20 μm, “SB-100” manufactured by Nihon Koken K.K.). The mixture was heated at 200° C., kneaded, and solidified in a cold water to cut into a pellet. The pellet was dried at 90° C. for 2 hours, then heated at 180° C., kneaded, and extruded into a sheet having 10 cm of width and 0.2 mm of thickness to form a primary sheet. The observation by a section photograph of this primary sheet revealed that the platelike particle was dispersedly orientated along the sheet surface. Hereinafter, as a coordinate system, an extrusion direction of a primary sheet is taken as X-axial direction.

<Block Fabrication and Slicing>

This primary sheet was cut off by a length of 30 cm along the X-axial direction to make strips, and as shown in FIG. 2, 400 pieces of the strip-like primary sheets were laminated (or layered) in almost the vertical direction. The multilayer mass 12 was heated to 160° C. with pressing the both sides and the upper side thereof to weld the primary sheets of the multilayer mass each other, and a welded multilayer block (block) 13 was produced. Incidentally, as a coordinate system, the laminating direction of this block 13 and the height direction thereof are taken as Y-axial direction and Z-axial direction, respectively. The size of thus obtained block was 30 cm in the X-axial direction, 20 cm in the Y-axial direction, and 10 cm in the Z-axial direction. This block 13 was cut into slices having a thickness of 0.1 mm along the X-axial direction (X-Y plane) so that the Z-axial direction was taken as the thickness direction to obtain a light control sheet 14 having a length of 30 cm and a width of 20 cm. Incidentally, FIG. 2 shows the schematic diagram expressing the production process of the primary sheet and block, and the light control sheet, as well as the coordinate system.

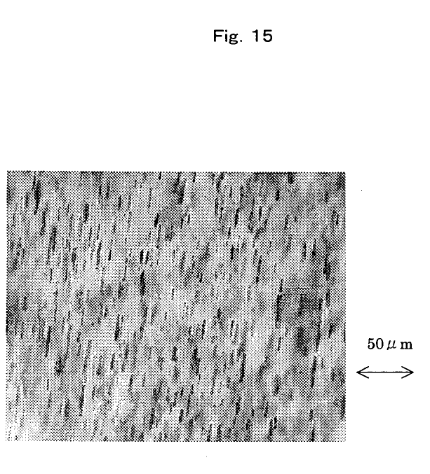

FIG. 15 shows a cross sectional view (photomicrograph) along the Y-Z plane of thus obtained light control sheet 14. In the sheet, the platelike particle was uniformly oriented so that the plate surface was directed to the Y-axial direction, and the angle of plate surface of the mica fine particle to the sheet surface was substantially 85°.

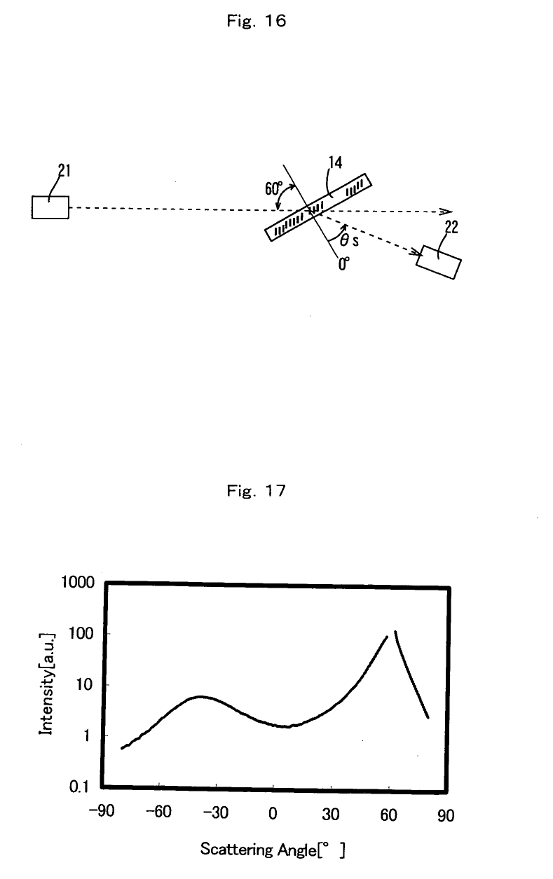

As shown in FIG. 16, this light control sheet 14 was attached to a light scattering measurement apparatus (“Goniophotometer” manufactured by Murakami Color Research Laboratory) so that the X-axis became a rotation axis. Using a parallel white light source 21, a rectilinear white light was entered at an incidence angle of −60° from the normal line relative to the sheet surface, and an angle of a light-receiving member 22 was varied at an angle θs around the X-axis as a rotation axis to measure the scattering intensity versus angle.

The measurement results are shown in FIG. 17. In the figure, the scattering angle of 0° means a normal direction relative to the sheet surface. As apparent from the figure, the light control sheet is allowed to direct part of the incident light to a counter direction relative to the incident direction.

### Example 12

The light control sheet of Example 11 was attached on a wedge-shaped light guide plate shown in FIG. 4 through a transparent adhesive layer to produce a back light unit A(a one-sided light source lamp-mode back light). Further, a prism sheet (“63 Grade” manufactured by Mitsubishi Rayon Co., Ltd.) was installed on the light control sheet to obtain a back light unit B (a one-sided light source lamp-mode back light).

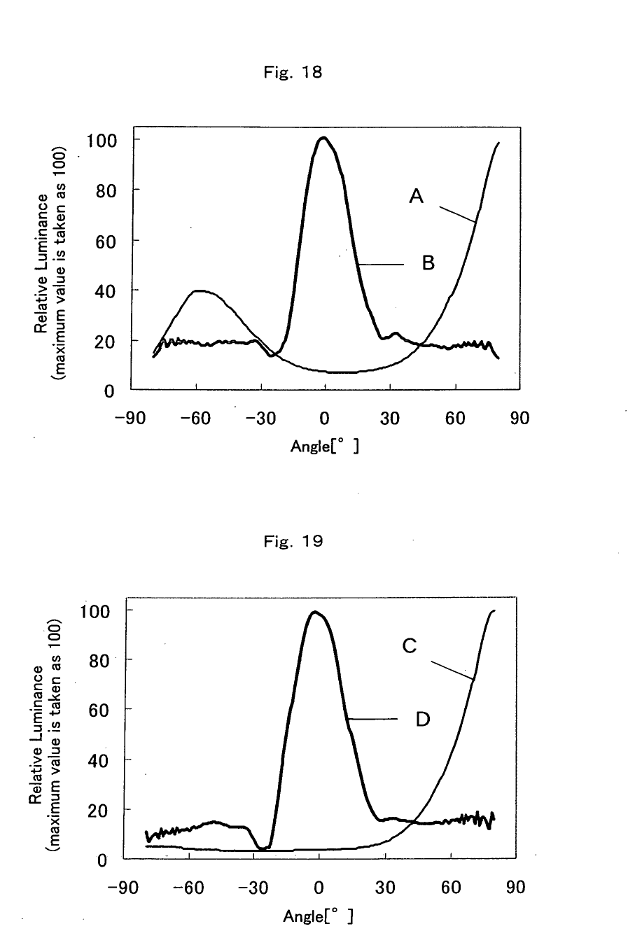

In the back light unit A, concerning an outgoing light transmitted from the light control sheet through the wedge-shaped light guide plate, the angle dependence of relative luminance (or relative brightness) in the plane perpendicular to the axis of the tubular light source lamp was measured by a luminance meter (“CS-1000” manufactured by Minolta Co., Ltd.). Moreover, also concerning an outgoing light from the prism sheet of the back light unit B, the angle dependence of relative luminance (or relative brightness) was measured in the same manner as mentioned above. The results are shown in FIG. 18, and in FIG. 18, the maximum luminance is taken as 100.

### Comparative Example 1

In the back light unit shown in FIG. 4, a back light unit C was produced without attaching the light control sheet to the wedge-shaped light guide plate. Moreover, in the back light unit shown in FIG. 4, a prism sheet (“63° Grade” manufactured by Mitsubishi Rayon Co., Ltd.) was directly installed on the light guide plate to give a back light unit D. In each of these back light units, concerning an outgoing light transmitted though the light guide plate, and an outgoing light from the prism sheet, the angle dependence of relative luminance (or relative brightness) was measured in the same manner as in Example 12. The results are shown in FIG. 19.

As apparent from FIG. 19, in the case not installing the light control sheet, the decline of the luminance is observed around an angle of −20 to −30°. Since the decline of the luminance is recognized as a dark line on the display panel, the display quality is deteriorated. On the contrary, as apparent from FIG. 18, the attachment of the light control sheet alleviates the asymmetric property of the outgoing light transmitted from the light control sheet through the wedge-shaped light guide plate. Further, even in the outgoing light transmitted from the prism sheet, as apparent from FIG. 18, the drop of the luminance is lost around an angle of −30° and the symmetric property of the angle dependence of brightness (or luminance) can be improved, and therefore the display quality can be drastically improved.

1. A light control sheet comprising a transparent resin and a platelike particle dispersedly oriented in the resin, wherein the direction of the plate surface of the particle is perpendicular to or inclined toward the sheet surface, and the platelike particle comprises at least one member selected from the group consisting of a transparent particle and a reflective particle.

2. A light control sheet according to claim 1, wherein the angle of the plate surface of the platelike particle to the sheet surface is 45 to 90°.

3. A light control sheet according to claim 1, wherein the platelike particle comprises a transparent particle, the mean diameter of the transparent particle at the surface direction is 5 to 200 μm, and the ratio of the mean diameter of the particle relative to the mean thickness thereof is 5 to 1000.

4. A light control sheet according to claim 1, wherein the platelike particle comprises a transparent particle, the mean diameter of the transparent particle at the surface direction is 5 to 200 μm, and the ratio of the mean diameter of the particle relative to the mean thickness thereof is 40 to 100.

5. A light control sheet according to claim 1, wherein the platelike particle comprises a transparent particle, the difference between the transparent resin and the transparent particle is 0.01 to 0.2 in refractive index, and the thickness of the sheet is 50 to 2000 μm.

6. A light control sheet according to claim 1, which comprises
a continuous phase comprising a transparent resin selected from the group consisting of a cellulose ester, an olefinic resin, a (meth)acrylic resin, a styrenic resin, a polyester-series resin, a polyamide-series resin, and a polycarbonate-series resin, and
a dispersed phase comprising at least one transparent platelike particle selected from the group consisting of a mica, a talc, and a montmorillonite,
wherein the plate surface of the platelike particle is oriented to the sheet surface at an angle of 45 to 90°.

7. A light control sheet according to claim 1, wherein the platelike particle comprises a transparent particle, and the angle of the plate surface of the particle to the sheet surface is 70 to 90° or 45 to 75°.

8. A light control sheet according to claim 1, wherein the platelike particle comprises a transparent particle, the angle of the plate surface of the platelike particle to the sheet surface is 70 to 90°, and the sheet is capable of selectively scattering or directing a light which is incident on the sheet surface from the front direction.

9. A light control sheet according to claim 1, wherein the platelike particle comprises a transparent particle, the angle of the plate surface of the platelike particle to the sheet surface is 45 to 75°, and the sheet is capable of selectively scattering a light which is incident on the sheet surface from an inclined direction.

10. A light control sheet according to claim 1, wherein the platelike particle comprises a transparent particle, and the sheet further comprises 1 to 100 parts by weight of a plasticizer relative to 100 parts by weight of the transparent resin.

11. A light control sheet according to claim 1, herein the platelike particle comprises a reflective particle comprising a particle and a metal or metal oxide coating the particle.

12. A light control sheet according to claim 1, wherein the platelike particle comprises a reflective particle, and the surface of the reflective particle is coated with titanium oxide.

13. A light control sheet according to claim 1, wherein the platelike particle comprises a reflective particle, and the mean diameter of the particle at the surface direction is 5 to 1000 μm, and the thickness of the sheet is 50 to 1000 μm.

14. A light control sheet according to claim 1, which comprises:
a continuous phase comprising a transparent resin selected from the group consisting of a cellulose ester, an olefinic resin, a (meth)acrylic resin, a styrenic resin, a polyester-series resin, a polyamide-series resin, and a polycarbonate-series resin, and
a dispersed phase comprising at least one reflective platelike particle which is selected from the group consisting of a mica, a talc and a montmorillonite, and has light reflectivity,
wherein the plate surface of the platelike particle is oriented to the sheet surface at an angle of 45 to 90°.

15. A light control sheet according to claim 1, which comprises 0.1 to 50 parts by weight of the platelike particle relative to 100 parts by weight of the transparent resin.

16. A light control sheet according to claim 1 for illuminating an object with a light source, which is used for a back light, wherein the back light comprises a light source and a light guide plate, and in the light guide plate, a light from the light source is incident on the lateral side of the light guide plate and is emitted from the front side of the light guide plate to illuminate the object from a back side thereof.

17. A method for producing a transparent resin sheet comprising a platelike particle dispersedly oriented to a given direction, which comprises laminating a plurality of transparent resin sheets in which the plate surface of the platelike particle is oriented along the sheet surface, welding these sheets to each other, and slicing the resulting matter in an intersecting direction relative to the laminating direction to obtain a light control sheet recited in claim 1.

18. A back light unit for illuminating a display unit from a back side thereof, which comprises:
a light guide plate for emitting a light being incident on a lateral side thereof from a front side thereof,
a light source disposed at the lateral side of the light guide plate, and
a light control sheet recited in claim 1 interposed between the emitting surface of the light guide plate and the display unit.
